(19) United States
(12) Patent Application Publication
(10) Pub. No.: US 2009/0057440 A1
(43) Pub. Date: Mar. 5, 2009

(54) ARRANGEMENT AND METHOD FOR PRODUCTION OF FOIL PARTS

(75) Inventors: Bernd Stein, Kirchzarten-Burg (DE); Reinhard Schnurr, Munstertal (DE); Wolfgang Friese, Freiburg (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: ZAHORANSKY AG, Todtnau (DE)

(21) Appl. No.: 12/197,442

(22) Filed: Aug. 25, 2008

(30) Foreign Application Priority Data
Sep. 4, 2007 (DE) 10 2007 041 948.3

(51) Int. Cl. B05B 15/00; B23P 17/00

(52) U.S. Cl. 239/289; 29/527.4

(57) ABSTRACT

An arrangement with a shaping device (5) for the production of foil parts from supplied foil material (3). At least one spray station (6, 10) for spraying plastic material onto the foil part at least in some areas is arranged after the shaping device (5).

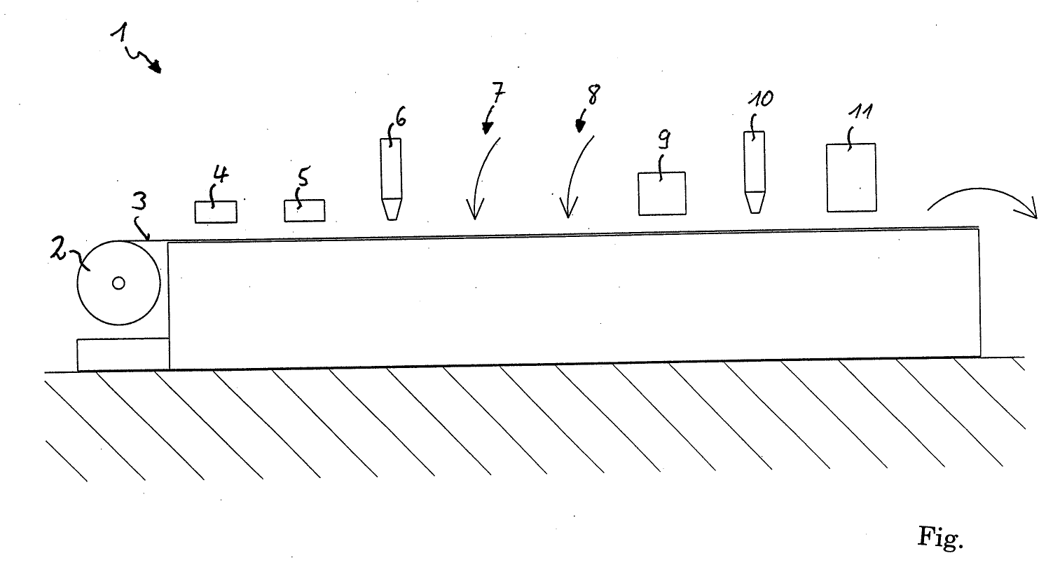

### CROSS-REFERENCE TO RELATED APPLICATIONS

This application claims the benefit of German Application DE 10 2007 041 948.3, filed Sep. 4, 2007, which is incorporated by reference herein as if fully set forth.

### BACKGROUND

The invention relates to an arrangement with a shaping device for the production of foil parts made from supplied foil material. The invention also relates to a method for the production of these foil parts.

Such devices for the production of open, shaped foil parts, for example, for blister packs or covers for computer keyboards, or similar objects are known and have been proven in practice. The foil parts produced in this way, however, have a simple composition and no other functional features beyond the property as a package or cover. In addition, for the most part these foil parts are not very attractive and therefore have no or only few properties that are effective for advertising, especially for use as a sales unit.

### SUMMARY

Therefore, there is the objective, in particular, to create a method of the type noted above, with which foil parts can be produced, wherein these foil parts have additional functional features and also an appealing outer appearance.

The solution according to the invention for addressing this objective is provided in that, downstream of the shaping device there is at least one spray station for spraying plastic material onto the foil part at least in some areas. Functional properties can be connected with this sprayed plastic material and the outer appearance of the foil part can also be improved, which can also have a beneficial sales effect. The plastic material can be sprayed or sputtered onto the surface of the foil part, optionally, it can also be injected into recesses or cavities of the foil part.

One embodiment provides that the shaping device is constructed for shaping open, shaped foil parts. Such shaped foil parts can be parts of a package, for example, a blister pack or functional parts, for example, covers for computer keyboards.

Another embodiment provides that the arrangement has a blister pack machine. With this machine, the shaped foil parts (blisters) can be loaded with an object, for example, a toothbrush, and then the open side can be closed with a cover. The spraying or injecting of plastic material can be performed after production of the shaped foil part on this part or on the package unit available after the blister pack machine.

To hold the shaped foil part during the spraying process and to define the spraying area, it is useful when the spray station has a shaping tool for the partial or complete holding of a foil part or the shaped foil part.

In order to be able to form, if necessary, various kinds of sprayed or injected-on parts on several sides or positions of the foil part, it is advantageous when several spray stations are provided for spraying the foil part at these positions or sides and/or a cover layer applied to the foil part with plastic material, and/or if the several spray stations are constructed for spraying or injecting plastic material of different colors and/or various plastic materials.

For spraying onto a cover layer, for example, a cardboard rear wall of a blister pack for a toothbrush, advantageously plastic material with a low melting point is used, in order to prevent damage or changes due to heat, such as discoloration of the cover layer.

The one or more spray stations can have several spray nozzles, advantageously for spraying different materials, in particular, different colored plastic materials. Thus, a variable spraying of the foil parts for an economical and space-saving configuration of the spray station is possible.

The one or more spray stations are advantageously constructed for spraying plastic material onto the foil part with a thickness in the range of less than one tenth up to a few tenths of a millimeter. Therefore, on one hand, only little material is needed for the spraying and, on the other hand, the spray station can even be realized in an economical and space-saving way. In addition, for the spraying of the plastic material, only very little time is needed, so that the number of cycles of the entire production arrangement is not negatively affected, that is, is practically not reduced by the spray process or processes, which has an economical effect on the production process.

It is useful when the one or more spray stations are constructed for the spraying or injection molding of an adjustment foot, suspension brackets, or similar functional elements from sprayed-on plastic material. In particular, blister packs can be provided with an adjustment foot so that they can be positioned, or can be suspended by the spraying-on of a suspension bracket, in order to be able to present the packages in a way beneficial for sales. Other functional elements, such as, for example, projections for better gripping of the shaped part or closing elements, in order to be able to close a package that has been opened, are also conceivable. Storage or blocking elements in the inner space of a blister bubble are also possible, in order to hold the object to be packaged, for example, a toothbrush, in a defined position.

In particular, if the sprayed-on parts are used as a standing surface for the foil part, it is advantageous when the plastic material to be sprayed is rubber-like. Therefore, a positioned foil part or shaped foil part is well secured against lateral displacement. So that the foil part also lies better in the hand, especially when it involves a blister pack, sprayed-on parts made from rubber-like material can be advantageous.

For the simple and quick spraying of add-on parts onto the foil part to be sprayed, a spray station can be arranged above or below the foil part to be sprayed, and the spray jet of the spray station can be oriented downward or upward to face the foil part.

To spray foil parts or closed blister packs simultaneously and thus in a time-saving way, at least one spray station can be arranged both underneath and also above the foil part to be sprayed and the spray jet of the spray station can be oriented upward and downward to face the foil part.

Additionally or alternatively, laterally arranged spray stations can also obviously be provided.

According to one embodiment, the one or more spray station can be constructed for spraying symbol-like markings. These markings can be, in particular, arrows, in order to point to important details of the package. Any other marking, however, such as, circles, crosses, etc., are also possible. In addition, signatures, company logos, or labels for packaged goods can also be provided as the symbol-like markings.

Another embodiment provides that the one or more spray stations for spraying plastic material are constructed as attachment elements for add-on elements deposited on the foil part. For example, for a transparent blister pack for toothbrushes, in the area of the brush head an optical enlargement element is attached by the sprayed-on parts or formed by the sprayed-on part itself, with which the rounded parts of the bristle strands can be better seen as a quality feature. It is also conceivable to deposit bristle material on the outside of the blister pack and to fix it with the sprayed-on plastic material, so that the customer can feel the bristle material before the purchase, in order to make a better purchasing decision.

Likewise, an effect that is beneficial for sales can be achieved if the one or more spray stations for spraying plastic material are constructed according to the material and/or the shape and/or the color of an object packed in the foil part. For example, the composition of the handle of a toothbrush can be patterned, in order to provide customers with a feel test in advance and in order to impart a feel for the handle properties of the toothbrush, without the package being opened, which is not possible for hygienic reasons.

Touch strips are also conceivable, for example, to impart the feel of a tongue scraper to the customer.

In particular, in handling hygienic articles, for example, toothbrushes or tongue scrapers, it is advantageous when the one or more spray stations for spraying plastic material are constructed as a tamper-evident closure of a blister pack. When the package is opened, such a sprayed-on part is damaged or ripped, so that it can be clearly seen that the package was already opened before, even if, for example, the cover layer of the blister pack has been bonded to the blister foil again.

A further embodiment of the invention provides that the one or more spray stations are constructed for spraying plastic material used as material reinforcement. This can be used, for example, for forming foil hinges, in that the foil material in the region of the provided hinge joint is first provided with a material weakening or perforation or even separated and then this region is sprayed completely or partially with plastic material. Therefore, the elasticity of the hinge joint can be improved and its durability can be increased.

For the use of elastic material, it is also possible to provide the one or more spray stations for spraying plastic material as a seal, in particular, along the outer extent of the foil part. The foil part with the surrounding plastic material then can be inserted into an opening of a container or a similar object, for example, as a closure stopper.

It is also conceivable that the one or more spray stations are constructed for spraying plastic material as a planar sprayed-on part over material recesses of the foil part. In a foil part, for this purpose, first a round recess is stamped, for example, over which is sprayed, in particular, colored plastic material. The foil part then can be used as a cover for a functional element, wherein, under the colored plastic sprayed-on part, for example, an electric push-button switch is arranged. This can also be used, for example, for emergency-switch systems, in order to clearly designate the emergency switch and to make them easier to operate. Conceivable are also activation surfaces, which enable an activation of individual buttons, for example, a remote control packaged in a blister, for test purposes.

The arrangement according to the invention thus allows the production of foil parts with new functional features as well as options that are beneficial to use and sales for only minimal extra costs relative to conventional foil parts without sprayed-on parts.

It is also possible to realize complete assembly systems with the spray station. For example, functional elements in the assembly process can be sprayed. Also, assemblies or circuits, for example, RFID transponders, can be sprayed and sealed with plastic material. A spray-specific assembly, for example, the production of a writing implement by spraying an ink cartridge with plastic material, which then forms the handle, is also conceivable.

The invention also relates to a method for producing foil parts, in which foil material is fed to a shaping device and deformed plastically. According to the invention, plastic material is sprayed on the shaped foil part for forming functional and/or decorative elements. This produces the advantages explained in connection with the arrangement according to the invention.

### BRIEF DESCRIPTION OF THE DRAWING

Below, an embodiment of the arrangement according to the invention will be explained in more detail with reference to the drawing.

The sole FIGURE shows: a greatly schematized representation of an arrangement according to the invention for producing foil parts with several processing stations arranged one after the other.

### DETAILED DESCRIPTION OF THE PREFERRED EMBODIMENTS

An arrangement designated overall with 1 for the production of foil parts (not shown in more detail) has a foil roll 2, from which the foil material 3 is unwound and is fed to the individual processing stations. After passing through a heating device 4 for heating the foil material 3, the foil material 3 is deposited on a shaping device 5 in the desired shape. The shaping device here can be constructed in a known and proven type and can have a shaping tool holding the foil in some regions, in which a punch travels, and pulls the heated foil into the desired shape.

A first spray station 6 is arranged after the shaping device 5. With this spray station, the shaped foil part is sprayed with plastic material. These sprayed-, sputtered, or injection-molded-on parts can be functional elements, decorations, or similar sprayed parts. In particular, for packages, plastic material can also be sprayed or injected into the inner cavity of the shaped foil part as a support element and for better holding the packed object in the blister bubble in the correct position.

In the FIGURE, at this location a single spray station 6 is shown. However, several spray stations can be provided one next to the other or one after the other for spraying different plastic materials or for applying sprayed-on parts at several positions. The spray stations do not necessarily have to be arranged in the shown alignment, but instead can also be arranged, for example, underneath the foil material for spraying the opposite side of the foil part.

After the spraying or injecting of the foil part with plastic material, at one positioning station 7, an object to be packed, for example, a toothbrush, is placed in the inner cavity of the blister-like shaped part and the blister bubble is closed at another processing station 8 with a cover layer or lid.

At one punch station 9, recesses or openings in the foil part and/or the cover layer can be formed, for example, suspension brackets for sales stands. It is also possible to form recesses in the foil part and/or the cover layer, over which plastic material is then sprayed by another spray station 10. With the second spray station 10, plastic material can also be deposited on the lid or the cover layer.

The foil parts still attached to each other as a foil web at this point are then separated at a separating station 11 into individual parts or packages and then ejected from the arrangement 1. In another production sequence, the individual foil parts or packages can be fed to a packaging device, in order to combine several parts in a larger packaging unit.

The sequence of individual processing stations of the arrangement 1 can be varied according to the application. Likewise, individual processing stations can be left out or others can be added. The construction of the arrangement 1 according to the invention is thus not limited to the shown embodiment.

1. An arrangement comprising a shaping device (5) for production of foil parts made from supplied foil material (3), and at least one spray station (6, 10) arranged after the shaping device (5) for spraying plastic material onto the foil part at least in some areas.

2. The arrangement according to claim 1, wherein the arrangement (1) includes a blister pack machine.

3. The arrangement according to claim 1, wherein the shaping device (5) is constructed for forming open, shaped foil parts.

4. The arrangement according to claim 1, wherein the at least one spray station (6, 10) includes a shaping tool for a partial or complete holding of the foil part.

5. The arrangement according to claim 1, wherein several of the spray stations (6, 10) are provided for at least one of spraying the foil part at several positions or sides, or to deposit a cover layer on the foil part with plastic material, or the several spray stations (6, 10) are constructed for spraying plastic material that have at least one of different colors or different plastic materials.

6. The arrangement according to claim 1, wherein at least one spray station (6, 10) is constructed to spray the foil part with plastic material with a thickness in a range from less than one-tenth up to a few tenths of a millimeter.

7. The arrangement according to claim 1, wherein the at least one spray station (6, 10) has several spray jets, to spray different colors of the plastic materials.

8. The arrangement according to claim 1, wherein the plastic material to be sprayed is a rubber-like material.

9. The arrangement according to claim 1, wherein the at least one spray station (6, 10) is arranged above the foil part to be sprayed and a spray jet of the spray station (6, 10) is oriented downward to face the foil part.

10. The arrangement according to claim 1, wherein the at least one spray station (6, 10) is arranged underneath the foil part to be sprayed and a spray jet of the spray station (6, 10) is oriented upward to face the foil part.

11. The arrangement according to claim 1, wherein the at least one spray station (6, 10) is constructed to spray symbol-like markings.

12. The arrangement according to claim 1, wherein the at least one spray station (6, 10) is constructed to spray plastic material as an attachment element for additional elements deposited on the foil part.

13. The arrangement according to claim 1, wherein the at least one spray station (6, 10) is constructed to spray plastic material as positioning feet, suspension brackets, or similar functional elements.

14. The arrangement according to claim 1, wherein the at least one spray station (6, 10) is constructed to spray plastic material according to at least one of a material, shape or color of an object to be packed in the foil part.

15. The arrangement according to claim 1, wherein the at least one spray station (6, 10) is constructed to spray plastic material as tamper-evident closures of a blister pack.

16. The arrangement according to claim 1, wherein the at least one spray station (6, 10) is constructed to spray plastic material as a material reinforcement.

17. The arrangement according to claim 1, wherein the at least one spray station (6, 10) is constructed to spray plastic material as a seal along an outer periphery of the foil part.

18. The arrangement according to claim 1, wherein the at least one spray station (6, 10) is constructed to spray plastic material as a planar sprayed-on part over material recesses of the foil part.

19. A method for the production of foil parts, comprising:
feeding foil material (3) to a shaping device (5) and plastically deforming the foil material; and
spraying plastic material onto the shaped foil part for forming functional or decorative elements.
